(19) United States
(12) Patent Application Publication
(10) Pub. No.: US 2003/0227173 A1
(43) Pub. Date: Dec. 11, 2003

(54) Floating electrical power production utilizing energy of sea waves

(76) Inventor: Vladislav Gorshkov, Alexandria, VA (US)

Correspondence Address: Vladislav Gorshkov, 3434A HOLLY ROAD, ANANDALE, VA, 22003, US

(21) Appl. No.: 10/163,570

(22) Filed: Jun. 7, 2002

(51) Int. Cl. H02P 9/04; F03B 13/10; F03B 13/12

(52) U.S. Cl. 290/53

(57) ABSTRACT

There are developed new technological methods converting a float bobbling caused by sea to direct electrical current charging accumulators carried by the float. The methods are embodied to design versions of the wave power plant. The central system, organizing the plant as the whole, is a system of accumulators' commutation. It is responsible for switching accumulators as intermediate receivers of the generated electricity, as storage and as source of it for further consumption.

The wave power plants are united in the single floating net, collecting electricity from the plants. In order to get practical result faster, the invention description contains method and calculus for hypothetical example of the floating plants' net, producing, collecting and delivering electrical power to consumers. There is shown also how to allocate and to fix the net along seashore.

Taking in account that fuel resources are limited on the Earth and they are allocated by the other way as the desirable, we can find the new methods of energy supplying as very profitable.

### CROSS-REFERENCE TO RELATED APPLICATIONS

An application Ser. No. 09/777.846 (Floating power production energized by seas and supported by gyroscope) has created two methods of the floating power production. The first one is based on usage a gyroscope as a fulcrum axis needed to reveal spin moments and motions of ship pitching and, so, to extract its energy for services. The second one use a submerged body of great inertia and water drag as a fulcrum revealing a float bobbling and extracts its energy. This method uses a spring providing oscillating mode of operation, i.e. it recovers the system to initial state before each wave rises.

The new two methods are added here in the floating power production. One of them uses foil disks threaded on a dangling long shaft. When bobbling they revolve the shaft that then revolves an electrical generator fixed in the float. The another new method uses a submerged body having a great water drag (as mentioned above) or an anchoring device as a fulcrum. However, it uses a sinker, instead of the spring to restore the system to the initial state before each wave rises. Also here is given a method connecting the floating power plants into a single power net.

### STATEMENT REGARDING FEDERALLY SPONSORED R & D

The author created the invention by himself with own means in duty free time.

### REFERENCE TO A MICROFICHE APPENDIX

Not Applicable.

### BACKGROUND OF THE INVENTION

Endeavor:

Abundance of wave energy in seas opens possibility of extracting and using it for power supply settlements of the seashores and future ocean settlements. This invention creates methods of extracting sea energy with new devices and system for industrial power production using energy from sea waves.

Front use wave energy by this way, the next problems arise and must be resolved.

1. Conversion of vertical reciprocating motions of the bobbling float to revolution of the electrical generator.

2. Discipline and system for produced energy storage in alternating conditions of power generating and its consumption.

3. Collecting electrical current from a net of the floating power plants.

Benefits of a floating electrical power production are:

It diminishes fuel consumption and country dependability on fuel sources;

Power supply coastal strip settlements, remote regions and islands;

Conversion and transmitting part of energy to standard land electrical net;

Building cheapest rocking powered house-boats for marine settlements;

Creating and building nautical bases supplying itself and mooring fleet with electrical energy, produced by floating power plants;

Use wave power plants on sea-going ships and vessels.

### BRIEF SUMMARY OF INVENTION

The general idea of the claimed invention is the utilization of sea waves energy to electrical power for land and sea resided consumers. Actually vertical float bobbling is used here as the source of the wave energy. The invention gives different ways to convert float-bobbling motion to electrical generator shaft revolution with a certain torque. Also it gives the method and switch system schema controlling distribution of produced (input) power between storage elements as well as between storage elements and output.

### BRIEF DESCRIPTION OF SEVERAL VIEWS OF DRAWINGS

FIG. 1. Floating electrical power plant using the battery of rotating spring foil disks treaded on a shaft that drives a plant generating and converting electricity. Accumulators store it before distribution and consumption.

FIG. 2. Floating electrical power plant using the foil pack separating relative motion of rising float and converting it (via: a tackle, a cog-belt drive, a differential block, overrunning clutches, and a spring muff) to an electrical generator shaft revolution.

FIG. 3. The body resisting ascend it by the float but it is easy carried down by the sinker caught it, while the float descends along with a wave (section AA from FIG. 2).

FIG. 4. Diagram showing conversion of alternating current to constant electrical current.

FIG. 5. Moving up and down an elastic foil disk creates a torque in mounting point.

FIG. 6. The permanent anchoring using instead the foil pack in case of shallow water.

FIG. 7. Electrical schema controlling switching accumulators depending in/out powers.

FIG. 8. Diagrams show instantaneous states of storage set of the power plant.

FIG. 9. The local offshore net of the power plants feeding parallel an electrical power station residing on a shore.

NUMERIC SYSTEM SIGNING ELEMENTS AND PARTS OF SYSTEMS

Tens| . . Units . .

| | | | | |
|---|---|---|---|---|
| 0:0 | 1-bridge, | 2-hatch, | 3-tambour, | 4-extension, |
| 5-porthole, | 6-fence, | 7-power plant, | 8-gear wheel, | 9-bush, |
| 1:0-gear box, | 1-generator, | 2-accumulator, | 3-fence, | 4-circle pathway, |
| 5-antenna, | 6-control stand, | 7-stiffening rib, | 8-main tube, | 9-lock screw, |
| 2:0-bush, | 1-bottom, | 2-floor, | 3-torus vessel, | 4-spin rest rib, |
| 5-gimbal, | 6-drive shaft, | 7-shaft-carrier, | 8-disk hub, | 9-spring disk, |
| 3:0-eye, | 1-bearing, | 2-sinker, | 3-front edge, | 4-rear edge, |
| 5-belt gear, | 6-cog-belt, | 7-bevel gear, | 8-shaft, | 9-bevel gear, |
| 4:0-rounding, | 1-bevel gear, | 2-shaft, | 3-internal dram, | 4-spiral spring, |
| 5-dram, | 6-connection, | 7-compartment, | 8-spare feeding, | 9-sheave block, |
| 5:0-rope, | 1-converter, | 2-connector, | 3-catch, | 4-spring, |
| 5-termination, | 6-upper foil, | 7-flap, | 8-flap rest, | 9-side flap, |
| 6:0-flap rest, | 1-lower foil, | 2-rib, | 3-sheave block, | 4-voltage curve, |
| 5-transit tube, | 6-belt channel, | 7-hinge, | 8-slot, | 9-flap hinge, |
| 7:0-contiguity, | 1-internal edge, | 2-pontoon, | 3-terminals, | 4-disk holder, |
| 5-anchor rope, | 6-concrete boom, | 7-anchor, | 8-ground, | 9-output bus, |
| 8:0-output bus, | 1-switch, | 2-input bus, | 3-input bus, | 4-short, |
| 5-cable, | 6-pier, | 7-boat, | 8-station, | 9-electrical line, |
| 9:0-post. | | | | |

### DETAILED DESCRIPTION OF INVENTION

1. The Sea Waves Energy Potential.

As [1] shows, total specific energy in sea waves is given by the formula

e=1255.68 H\hat{ }2 (J/m\hat{ }2). (1)

So for waves of high 2 m average energy per one square meter (specific wave energy) is evaluated as 4902.72 J=4902.72 W·s≅4.9 kW·s. Let's to take in account other average parameters of such wave [2]: period 4.5 s, length 32 m, and velocity 7.1 m/s. It means that the power passing cross section of 1 m long (specific wave power) is evaluated as p=34.8 kW. If we catch the wave energy on cross line of 1000 m long then we potentially can get 34.8 megawatts. Even though having a system with efficiency of only η=0.1, we get P=3.48 megawatts per one km of the energy catch line. The potential power of wave power plants, united into the net on the energy catch line with length L, for known wave height H and wave velocity V is calculated by formula:

P=η·1255.68 H\hat{ }2·V·L (watt). (2)

For another example with H=3 m, we have the specific wave energy e=11.3 kW·s and velocity V=8.5 m/s. It means the specific wave power is evaluated as p=96 kW and our power production system with efficiency of only η=0.1 makes power P=9.6 megawatt. This example shows output instability of the wave energized floating power plants. It makes necessity to accumulate excess of produced power and distribute it in time of calm sea. The other possible way to overcome the instability is the combining of the wave power plants with other energy sources.

2. Disk Converter of the Vertical Reciprocating Motions to Shaft Revolution. claim-1.

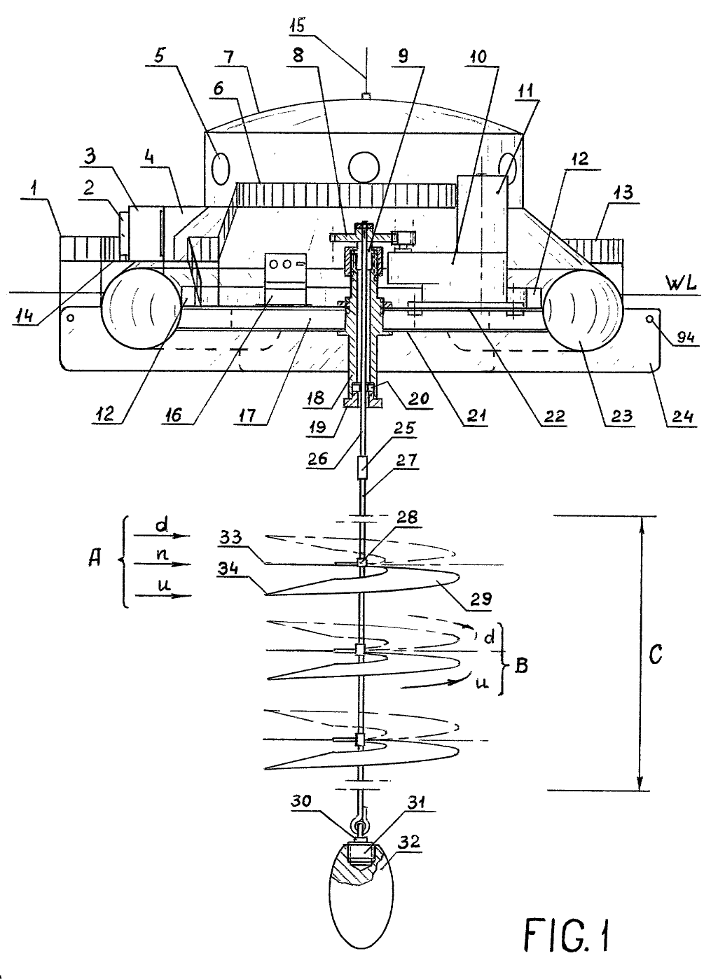

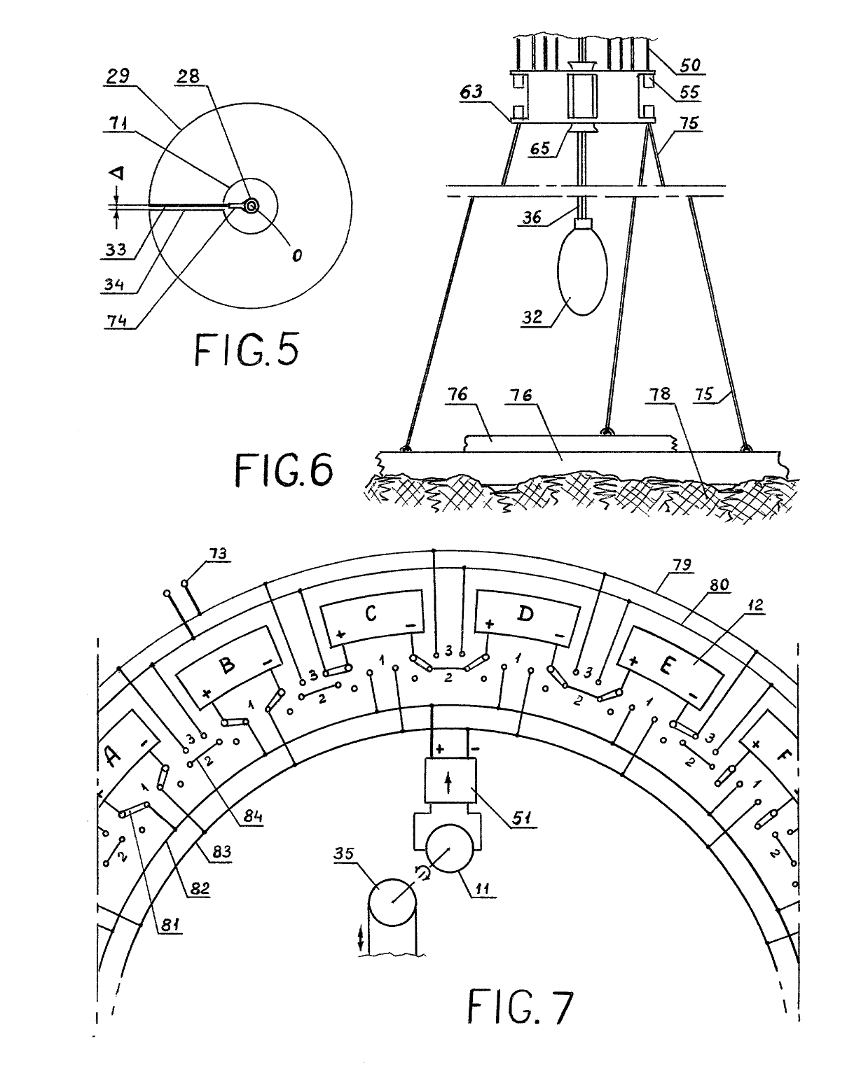

FIG. 1 shows the disk converter on section C between two breaks as a part of the whole wave power plant. Also its single slit disk is shown on the FIG. 5. When the shaft 27 (it can be also flexible [3], page 33), holding a set of the slit disks 29, reciprocates, the disks interrupt free motion experiencing water drag pressure. The pressure is distributed uniformly on the disk surface. Due to small slit's size (Δ) the total drag force applies directly to the center of disk o (FIG. 5), i.e. to the shaft 27 through the hub 28. So the shaft 27 does not experience any bend moments. The slit Δalso allows the rear disk edge to pass freely the neutral state (n) and occupy (FIG. 1) extreme positions (d and u).

However, the thin disk, made from elastic material, is springy deformed and shaped by the water drag pressure into spiral figure likewise a screw. It causes generation of torque on the surface of the temporally spiral formed disk. The disk 29 transmits said torque to the shaft 27 via the hub 28 and revolves it (if resistance of the shaft does not exceed the generated torque). Each shaft rectilinear stroke redirects or reforms the disk spiral so as in any case the generated torque saves its direction as well as the shaft saves the direction of its revolution. Really the disks generate one way revolution.

The brace A (FIG. 1) shows three positions of the rear disk edge 34 for three states of the shaft 28: d and u—respectively downward and upward rectilinear motion; n—neutral motionless state. The brace B shows single direction of the revolution of the disk 29 and shaft 27 for downward and upward rectilinear motion of them (d and u). To change the disk revolution direction, we need to change the disk edge that the disk mounted with to the shaft 28.

3. The Power Plant Using the Disk Converter of Reciprocating to Revolution. claim-4.

The described disk converter is used in an electric power plant (FIG. 1). Its float bobbling body 7 is the source of reciprocation. The internal shaft 26 is held inside the main tube 18 with the top nut on the gear 8. It is also centered on the main tube with the bearings 9 and 20. This shaft accepts spin motion from the external shaft 27 of the converter with the gimbal 25 allowing the plant body 7 to be pitched. When the plant body 7 descends, the sinker 32 moves the converter down. In order to reduce the sinker spin inertia, it can be hinged with bearing 31. But on the other hand, when the revolution speeded up, direct fixing it on the shaft 27 allows us to use the sinker inertia to stabilize process.

To generate electricity the gear 8, set on the shaft 26 with a key, drives the generator 11 through the gearbox 10. Generated electricity voltage is shown on the FIG. 4 as an input voltage Uᵢ delivered to the transformer 51 smoothing outputting voltage Uₒ for charging the accumulators 12. The control stand 16 provides normal work for charging accumulators and switching them to feed the customer electrical net.

The torus vessel 23 provides the plant floodability and the ribs 24 resists to revolution the plant body 7 together with the shafts 27 and 26. They serve here as the spin fulcrum making possible to extract wave energy.

4. A Belt Converter of the Vertical Reciprocating Motions to Shaft Revolution. claim-2.

The great resistance is created by the body design. It is made with the foil disks 56 and 61 connected by the ribs 62, which also provide the body rigidity.

The simplest converter consists of two cog-belts 36 passed over the cogwheel 35, a sinker 32 and a resisting body 56 (both) are hanged up to cog-belt ends. When the cogwheel 35 is risen by the float 7, resisting body 56 due to the great water drag holds own cog-belt ends almost motionless while the sinker is risen by other cog-belt ends. As a result the cog-belts 36 revolve the cogwheel 35 and so the shaft 38 to one direction. When the float 7 descends, the resisting body eliminates its water drag and unbalanced sinker rushes down revolving the cogwheel 35 and the shaft 38 back with the cog-belts 36.

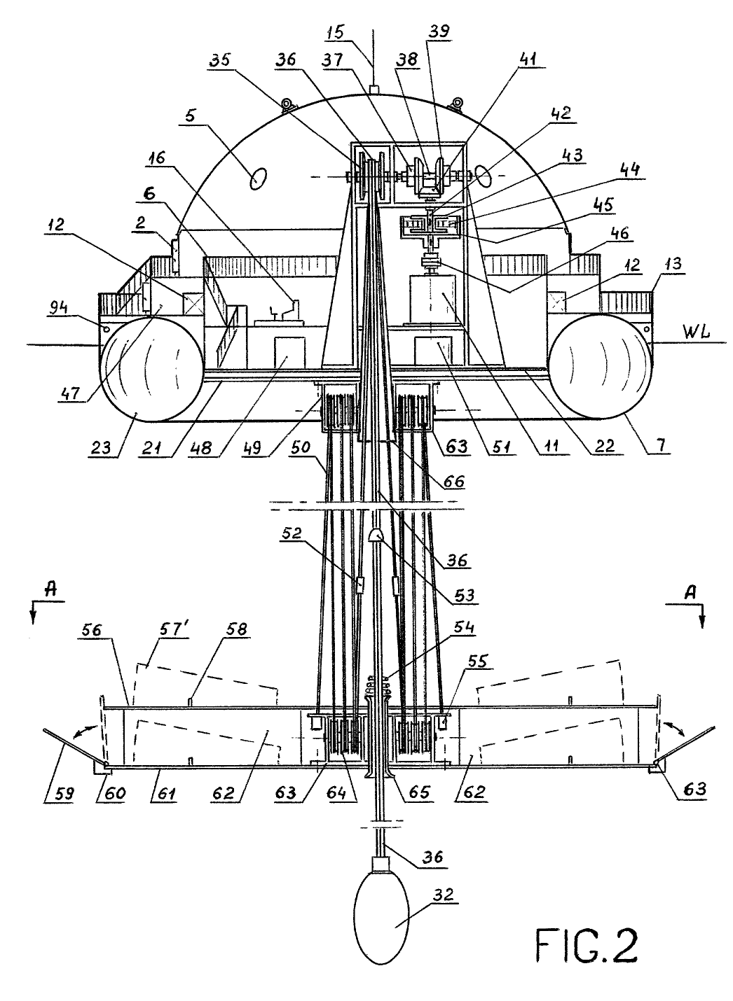

The simplest converter experiences great loads. To facilitate the converter load, here is used the tackle hanging the resistance body 56 to the bottom 21 of the float 7 with blocks 63. Each rope 50 is filling its own tackle block 63. A rear row of the rope lines is not shown in the FIG. 2. One end of each rope is fixed to the resisting body 56 with mounting 55 while the other end is connected to the corresponding belt 36 with the connector 52. Suppose the distance between the float bottom 21 and the resisting body 56 changes by a value d and the length of the belt 36, passed cross the bottom, is designated as l. Accordingly the tackle rules it is defined as l=n·d, where n—quantity of lines (including the belt) hanging the lifted body. So for our picture l=8d.

claim 3.

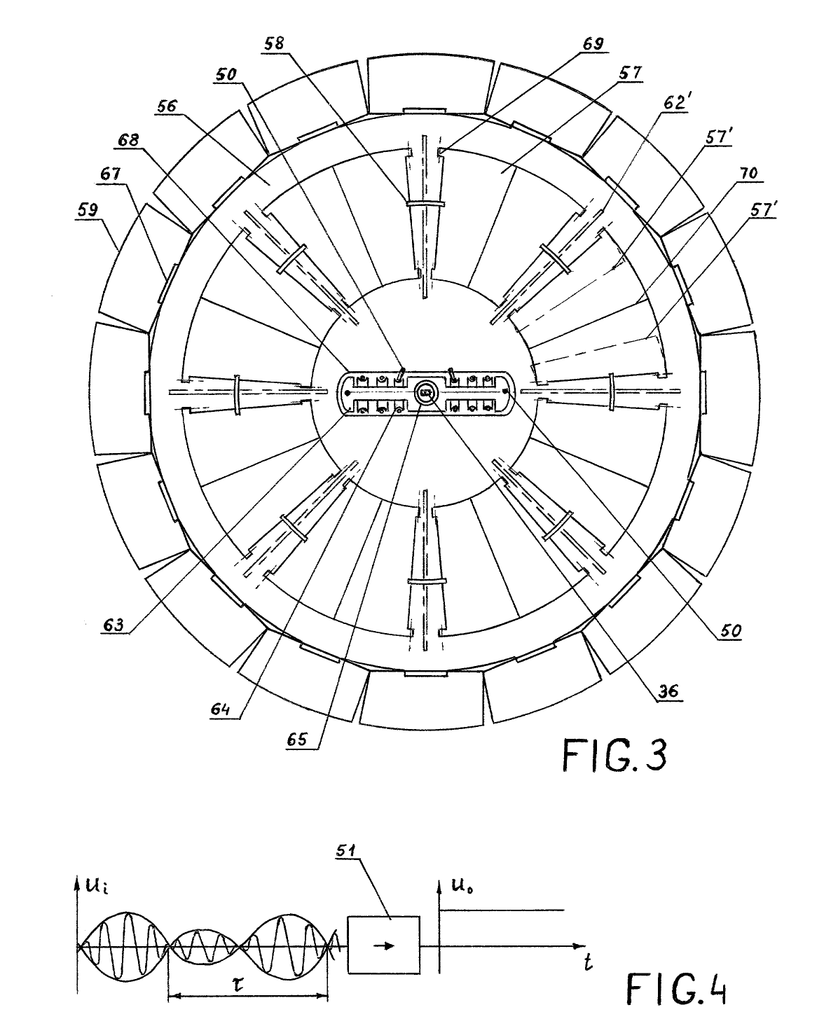

The second improvement allows the resistance body faster to sink, when the float 7 descents, in order to be prepared for the float the next ascend. For that it has flaps 57 on either foil disk 56, 61 (FIGS. 2, 3). Also side flaps 59 (resisting, when the body is lifted) are closing to allow free sinking. That process starts since the sinker 32 lowers so much as the catch 53, fixed on the belt 36, bumps into the spring 54. Note that the belt 36 entrained by the sinker 32 slides freely through the resistance body 56 inside the pipe 65.

5. Hard Anchor Converter of the Vertical Reciprocating Motions to Shaft Revolution.

The hard anchor converter “reciprocation to revolution” is very similar to the belt converter described above (p. 4). Only, instead of the resistance body (FIG. 3), here are used anchoring devices 75, 76 (FIG. 6) holding hard the tackle block 63 and, so, creating the fulcrum needed to drive the cog-belt 36 when the float 7 ascends. Also the anchored tackle block does not need to be lowered down because it keeps its position steady. Due of it the catch 53 is not needed here as well as the spring 54.

6. Wave Power Plant Using the Belt Converter of Reciprocation to Revolution. claim-5.

The wave power plant can use either considered anchoring device to get the alternative revolution of the shaft 38. That kind revolution is transformed to constant revolution by the bevel gears 37 and 39 united with the overrunning clutches. So the bevel gear 41 and the shaft 42 revolve direct. Then the spring muff 44 softens the revolution to the uniform revolution of the generator 11. The generator can produce alternative current of alternative frequency, voltage and power. Or it can be a direct current generator and produce direct current with alternative voltage and power. Even it can stop power producing while a sea is calm.

In either case the converter 51 converts the generated current to the direct current of constant voltage charging accumulators. Here (FIG. 2) accumulators 12 (storage) are locating in a special storage compartment 47. The power, stored first by accumulators, must be controlled accordance with the generated power. This is sharp distinction from the standard electrical plant where its power is automatic controlled accordance with consumed power. The generating power alternations are compensated here by variable quantity of the accumulators connected up.

7. Method and System for the Wave Power Plant Commutation. claim-6.

7.1. Conceptual Basics.

As we see, the intermediate electricity storage can consist of tens and hundreds accumulators which should be accurately connected to the input buses 82, 83 (FIG. 7), temporarily disconnected and then again connected to the output buses 79, 80 in order to provide for:

Maximum wave energy extraction;

Reliable energy storage for proper use in time of small waves;

Reliable delivery energy to local consumers or to electrical net.

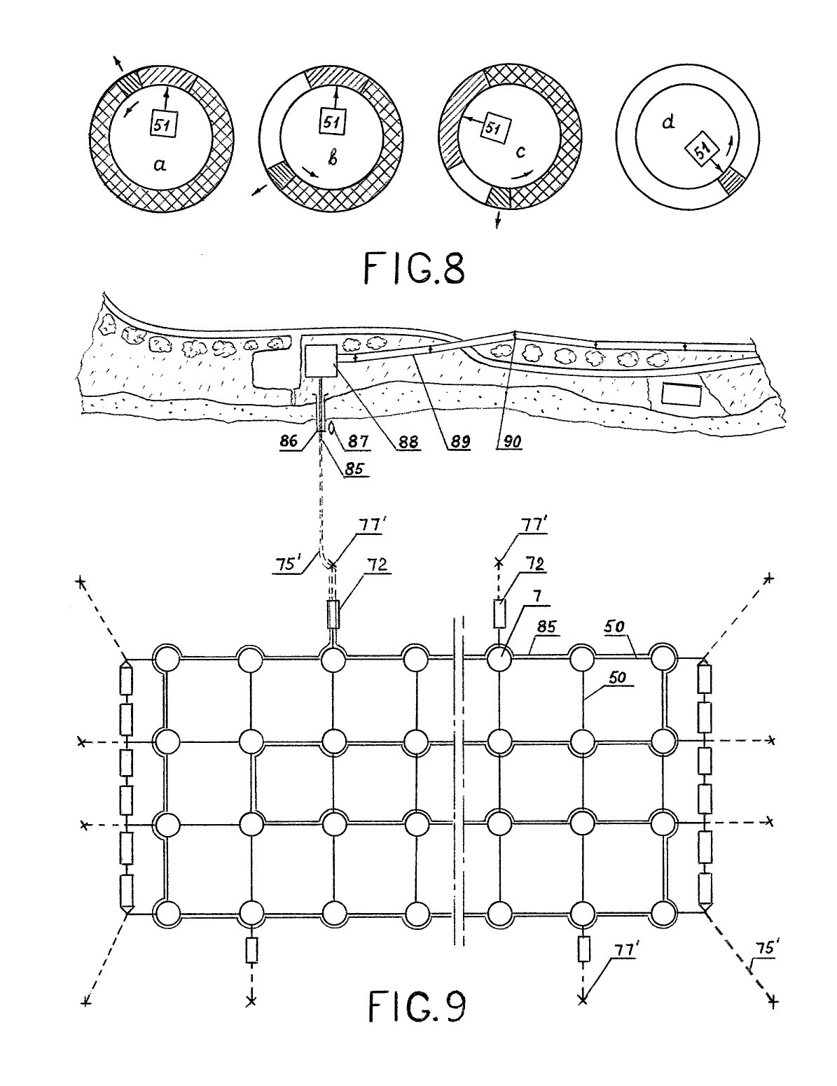

Below is described the method conformed to enumerated requirements. Let's first to see the FIG. 8. The rings a, b, c, and d show different states of the accumulators storage. Left tilted hatch shows issue storage zone, issuing the electricity to the consumer net. The right tilted hatch shows input zone, accepting the electricity from the converter 51. The double hatched zone is storage ready to be used. At last the white zone is the discharged storage.

The wave plant operation develops cyclically and directs opposite a watch arrow revolution. If the issuing zone is just discharged (become white; see the ring a) then this zone is disconnected from the output bases and disbanded. If the ready to be used storage exists front of just disbanded zone then the next portion of the ready storage of c accumulators (depending of output voltage) is connected consequently creating the new issue zone (circuit) and it is also connected to the output bases. The power issue continues.

If the energy consumption is high then the discharged zone (white) increases faster than the charged zone (double hatch; see the ring b) and it can be so happened that all storage is empty (see the ring d). In the example, before this situation occurred, the wave power increased (see the ring c) so as the greater portion p of accumulators is connected parallel to the input buses and is charged.

The control system should measure the input power and calculate how many “empty” accumulators p in the next portion will be connected to the converter input buses. It should also measure energetic state of issuing accumulators circuit to prognosis its operating time before disconnection.

7.2. Storage Commutation System.

The storage commutation system for the wave power plant (FIG. 7) is destined to control the accumulators storage system accordance with the power, being delivered from waves by the plant systems to the input buses 82, 83, and the power, being consumed from output buses 79, 80 through output terminals 73. Each accumulator pole is continued with the turn contact (switch) 81 axis so as it can be connected to the switch terminals (1, 0, 2, 3).

The terminals of either pole switch is oriented symmetrically relatively each to other. So, when the contacts of both switches are brought together, they connect an accumulator with the input buses via the terminals 1. See accumulators A and B. If they are spread outsize then they connect an accumulator with the output buses via terminals 3. See accumulators C, E (FIG. 7). If closest switches of contiguous accumulators are set on terminals 2 then they connect both accumulators consequently through the short 84. See the accumulator D. When switch 81 of a single accumulator connects each to terminals 0 then the accumulator is disbanded (empty or ready to be used).

Thus in the most cases both switch contacts of the same accumulator are in one of the symmetrical states (1, 0, 2, 3). To create an issue consequent storage circuit it is enough to set contacts of all accumulators, included in the issue circuit, on the terminals 2 except of two extreme contacts which should be set on the terminals 3. See accumulators circuit of the accumulators C, D, E (FIG. 7). Here we discover that in some times (may be often) the control system can create several identical issue consequent storage circuits allowing to increase power issue from this power plant.

8. Uniting the Wave Power Plants to the Floating Power Net. claim 7.

As we can understand, the single wave power plant does not attract our great interest because there is exists the problem to deliver the power for consumers. Expanses for delivering power are much less if we collect and deliver great volume of extracted wave energy. FIG. 9 shows a possible solution of this problem. We see some offshore area of water covered by the net of the wave power plants. It can consist of several parallel rows of the wave power plants extending along a shore. The plants are first linked into the net with ropes 50. This net is fixed inside offshore area of water with pontoons 72 and anchor devises 77. They must hold the net in any weather conditions. Gaps between the wave power plants are great enough to eliminate possibility of any collisions and to provide free bobbling for each plant.

The electrical armored impervious cable 85 goes from the shore electrical station 88 to under water, lies on the bottom and surfaces up on the pontoon 72. Then it loops all plants using ropes 50 for attaching. Inside a plant, output bases connected to the cable 85 veins with terminals 73 (FIG. 7). So all issue circuits of all plants are connected parallel to these veins. After looping the cable 85 comes back to the station by the same way. If to accept the gap between the plants 50 m then the 3-row net of catch line 5 km contains 300 plants. Continuing our example from p. 1 we ought to wait that our wave station produces the electrical power P=17.4÷48 megawatts during the waving of 2÷3 m high if the total efficiency factor η=0.1.

Technical Literatures:

[1] E. C. Pielou. The energy of Nature. Printed by the University of Chicago. 2001.

[2] Sea going captain handbook. Edited by G. G. Ermolaev. Moscow “Transport”. 1988.

[3] D. N. Reshetov. Parts of machines. Moscow “Machinostroenie”. 1989.

1. Method and a disk converter transforming a bobbling float vertical reciprocating motions to one way revolution of a vertical shaft submerged from the float to extract power of sea; slit thin elastic disks are treaded on the shaft and rotates it because of water resistance imparts them spiral shape when the shaft reciprocates.

2. Method and a belt converter transforming a bobbling float vertical reciprocating motions to a horizontal shaft spin oscillation; the shaft is engaged with a cog-sheave passed over by the belt reciprocating due of alternative imbalance of forces pulling its ends down: sinker gravity and an anchoring device resistance.

3. An anchoring device (as mentioned in the claim 2) shaped as a block of parallel foil disks creating hydrodynamic drag, alternatively hard resisting to ascend and almost unresisting to descend at expense of flap openings; thus it freely sinks in descending to occupy the lowest initial position before to restart operating as an anchor.

4. A floating power plant, using a disk converter (according to the claim 1) to transform the plant bobbling to revolution of a vertical shaft driving a generator; its electrical current after conversion recharges accumulators that cyclically selectively switched to output buses then again switched to input bases for recharging.

5. A floating power plant (according to the claim 4) where instead the disk converter used a belt converter (according to the claim 2) producing a horizontal shaft spin oscillation that after transforming to uniform revolution drives a generator.

6. Method and system providing commutation of the plant accumulators with flexible automated assembling sequential circuits, switching them to output bases—for discharging, disassembling the sequential circuits, switching them to input bases—for charging, and switch them off after any of said operating modes.

7. Method uniting collection of the floating power plants to a floating offshore electrical power net holding the plants together in prescribed area of water, collecting and delivering generated power to a shore electric station for further possible additional converting and subsequent distribution to consumers.

8. Method of electrical power production utilizing energy of sea waves with bobbling floats built as floating power plants (according claim 4 or claim 6) producing direct electrical current outputted to a floating power net (according claim 7), which holds the plants in prescribed area of water, collects and delivers the power to consumers.
